(19) United States
(12) Patent Application Publication
(10) Pub. No.: US 2003/0167914 A1
(43) Pub. Date: Sep. 11, 2003

(54) Cushion cylinder device

(76) Inventor: Shigehiro Arai, Chiba (JP)

Correspondence Address: Adams & Wilks, 50 Broadway 31st Floor, New York, NY, 10004, US

(21) Appl. No.: 10/332,556

(22) PCT Filed: Apr. 3, 2002
(86) PCT No.: PCT/JP02/03364

(30) Foreign Application Priority Data
Apr. 25, 2001 (JP) 2001-127848

(51) Int. Cl. F15B 15/20

(52) U.S. Cl. 91/392

(57) ABSTRACT

Disclosed is a cushion cylinder device allowing high accuracy setting of a cushion operation start position. At the cushion operation start position of a driving cylinder, a first engagement member provided on a piston rod of the driving cylinder abuts a second engagement member provided on a piston rod of a cushioning cylinder, whereby the driving cylinder undergoes deceleration through cushion operation of the cushioning cylinder.

### BACKGROUND OF THE INVENTION

1. Field of the Invention

This invention relates to a cushion cylinder device.

2. Related Background Art

In various machines and apparatuses, a cylinder device operated by fluid pressure such as hydraulic pressure is used for the purpose of moving objects such as tools, workpieces, and goods. For an improvement in operational efficiency, the movement is required to be of high velocity. At the same time, the movement is required to be soft from the viewpoint of safety for the object to be moved and the peripheral objects and prevention of damage. The less the amount of soft movement, and the more the amount of high velocity movement, the higher the operational efficiency. Thus, it is desirable to control the soft movement amount in tenths of a millimeter and to make it as short as possible.

In view of this, a cylinder device with a cushioning effect is frequently used which moves at high velocity and decelerates as it approaches a target position until it stops gently.

Conventional examples of the cylinder device with a cushioning effect include a cushion cylinder device in which a cushion mechanism is provided inside a cylinder and a cylinder device in which switching is effected on a solenoid valve provided in a fluid pressure circuit for supplying or discharging fluid to and from a cylinder.

FIG. 5 shows an example of a conventional cushioning cylinder. In FIG. 5, numeral 501 indicates a piston, numeral 502 indicates a cylinder tube, numeral 503 indicates an operation chamber containing operation fluid, and numeral 504 indicates a supply/discharge port through which the operation fluid is supplied and discharged. To move the piston 501 downwards and backwards as seen in the drawing, operation fluid is supplied to the operation chamber 503 through the supply/discharge port 504. Conversely, to move the piston upwards and forwards, fluid is supplied to an operation chamber 505 on the lower side (retreat side) of the piston 501 through a supply/discharge port (not shown) provided below the cylinder tube 502. No particularly great resistance is offered to the flow of the fluid supplied or discharged, and the piston 501 moves at high velocity according to the fluid pressure.

On the forward side of the piston 501, there protrudes a cylindrical cushion rod 506; when the piston 501 slides forward in the cylinder tube 502 to approach the end, the cushion rod 506 is inserted into a cushion spigot portion 508 provided in an end cap 507 closing the end portion of the cylinder tube 502. Clearance fit is effected between the inner diameter of the cushion spigot portion 508 and the outer diameter of the cushion rod 506; when the cushion rod 506 is inserted into the cushion spigot portion 508, the operation fluid flows through the narrow gap therebetween, and the flow of the operation fluid from the operation chamber 503 to the supply/discharge port 504 is interrupted, with the result that the piston 501 is decelerated and provides a cushioning effect.

When moving the piston 501 backwards, operation fluid is supplied to the operation chamber 503 through the supply/discharge port 504; at this time, a check valve 509 is operated by the fluid pressure from the supply/discharge port 504, so that the operation fluid flows into the operation chamber 503 by way of the check valve 509 and a flow passage 510, and even when the cushion rod 506 remains in the cushion spigot portion 508, the piston 501 moves backwards substantially at high velocity.

In this cushion cylinder device, a cushion operation stroke cs for the decelerating operation is fixed, and it is impossible to adjust the cushion operation start position with respect to the target stop position t of the piston 501.

Further, immediately after the entrance of the cushion rod 506 into the cushion spigot portion 508, the length of the gap between the cushion rod 506 and the cushion spigot portion 508 is small, and the fluid resistance is not decreased much; as indicated at a in FIG. 3, the deceleration is effected gently. Thereafter, the degree of deceleration is gradually increased. That is, there is actually no definite cushion operation start position, and it is very difficult to conduct fine adjustment in which the cushion stroke cs is adjusted in tenths of a millimeter. Further, there is a variation in the cushion operation due to dimensional errors of the parts, with the result that the operation differs from device to device; it is as indicated at a or b in FIG. 3. Further, if the cylinder is the same, the part dimensions vary due to variation in the temperature of the operation fluid, so that, with passage of time, the cylinder operation becomes as indicated at a or b in FIG. 3, with the cushion stroke cs varying.

When the variation in the cushion stroke generated with passage of time is not negligible, it is necessary to adjust the cylinder to the case in which the cushion deceleration time is long (a in FIG. 3). However, when the device is started with the condition of a in FIG. 3, if the mode as indicated at b in FIG. 3 is attained with passage of time, switching to a cushioning velocity cv is effected earlier than in the case of the mode a in FIG. 3, so that proportion of the cushion velocity cv at which the movement of the cushion stroke cs is effected increases, resulting in an increase in the cushion operation time.

Further, any slight error in dimension for clearance fit causes the cushion operation velocity cv to fluctuate (as indicated at d in FIG. 3), so that it is difficult to accurately set the cushion operation velocity. Further, an increase in dimension for clearance fit due to wear after long use also causes the cushion operation velocity cv and the cushion stroke cs to vary, resulting in an unstable cushion operation or a weakened cushion operation (as indicated at c in FIG. 3).

FIG. 6 shows an example of a conventional cylinder device based on solenoid valve switching. In FIG. 6, supply/discharge ports 602 and 603 of a cylinder tube 601 are respectively connected to a first control fluid circuit 604 and a second control fluid circuit 605, which are connected to an operation fluid supply source 606.

The first control fluid circuit 604 is provided with a first movement direction switching solenoid valve 607 and a first movement velocity adjusting portion 608; the second control fluid circuit 605 is provided with a second movement direction switching solenoid valve 609 and a second movement velocity adjusting portion 610; and the operation fluid supply source 606 is provided with an operation fluid circulating pump P.

Then, to move the piston 611 of the cylinder tube 601 at high velocity, the circuit is connected in such a manner that the first movement direction switching solenoid valve 607 and the second movement direction switching solenoid valve 609 are switched to thereby supply a large amount of operation fluid per unit time to one of the supply/discharge ports 602 and 603 by way of both the first control fluid circuit 604 and the second control fluid circuit 605, and a corresponding amount of operation fluid is discharged from the other supply/discharge port, whereby the piston of the cylinder tube 601 moves at high velocity. The high movement velocity is controlled by the first movement velocity adjusting portion 608 throttling the flow of the operation fluid.

When it is detected that the piston has reached a pre-set cushion operation start position, switching to low velocity movement is effected. That is, the circuit is connected in such a manner that the first movement direction switching solenoid valve 607 is closed, and operation fluid is supplied and discharged solely by way of the second control fluid circuit 605. The low movement velocity is controlled by the second movement velocity adjusting portion 608 throttling the flow of the operation fluid.

In this cylinder device based on solenoid valve switching, response delay occurs depending upon the piping distance from the solenoid valves 607 and 609 to the cylinder 602 and the material of the piping. Further, there is response delay also in the solenoid valves 607 and 609 themselves. Thus, it is difficult to adjust the cushion stroke cs in tenths of a millimeter.

### SUMMARY OF THE INVENTION

This invention has been made with a view toward solving the above problem. It is an object of this invention to provide a cushion cylinder device which allows high accuracy setting of cushion operation start position.

In order to solve the above-mentioned problems, according to the present invention, there is provided a cushion cylinder device including: a driving cylinder tube slidably retaining a driving piston; a cushioning cylinder tube slidably retaining a cushioning piston; a first engagement member provided on a driving piston rod of the driving piston; a second engagement member provided on a cushioning piston rod of the cushioning piston; and an operation fluid throttling means which when the cushioning piston advances, throttles the flow of operation fluid in the cushioning cylinder to reduce the moving velocity of the cushioning piston to thereby effect cushion operation, in which when the driving piston advances to cause the first engagement member to abut the second engagement member, the velocity of the driving piston is reduced through regulation by cushion operation of the cushioning piston.

Further, in the cushion cylinder device, one of a cushioning piston portion and a driving piston portion is formed as a sleeve-like piston portion, into which the piston rod of the other piston portion is slidably inserted to form the driving cylinder tube and cushioning cylinder tube into a concentric structure, or the throttling amount of the operation fluid throttling means is adjustable.

Further, in the cushion cylinder device, there is further provided a cushion stroke adjusting means for adjusting the stroke of the cushioning piston, and occasionally, the first or second engagement member also serves as the cushion stroke adjusting means.

Further, in the cushion cylinder device, there is further provided a driving stroke adjusting means for adjusting the stroke of the driving piston, and occasionally, the first engagement member also serves as the driving stroke adjusting means.

Furthermore, in the cushion cylinder device, the operation fluid in the cushioning cylinder is solely in an operation chamber on the forward side of the cushioning piston, and an operation chamber on the rearward side thereof communicates with the atmosphere.

### BRIEF DESCRIPTION OF THE DRAWINGS

In the accompanying drawings:

FIG. 1 is a front view showing an embodiment of this invention;

FIG. 2 is a circuit diagram showing the operation fluid circuit of FIG. 1;

FIG. 3 is an explanatory diagram illustrating the cushion operation of the operation piston of this invention;

FIG. 4 is a longitudinal sectional view showing another embodiment of this invention;

FIG. 5 is a longitudinal sectional view of a conventional cushioning cylinder; and

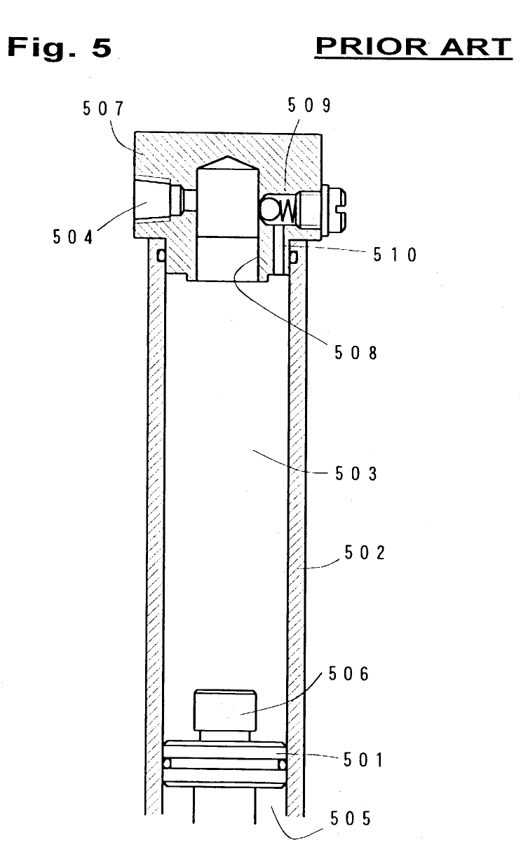

FIG. 6 is a circuit diagram showing a conventional cylinder velocity switching circuit using solenoid valves.

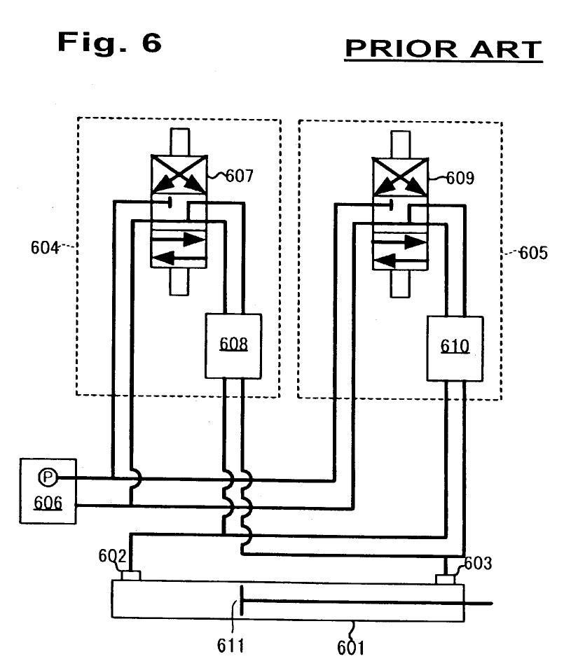

### DESCRIPTION OF THE PREFERRED EMBODIMENTS

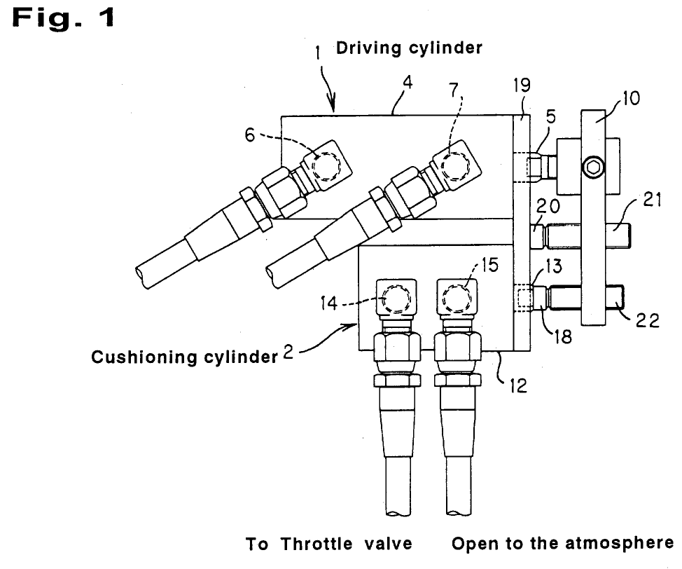

Embodiments of this invention will be described with reference to FIGS. 1 through 4.

First Embodiment

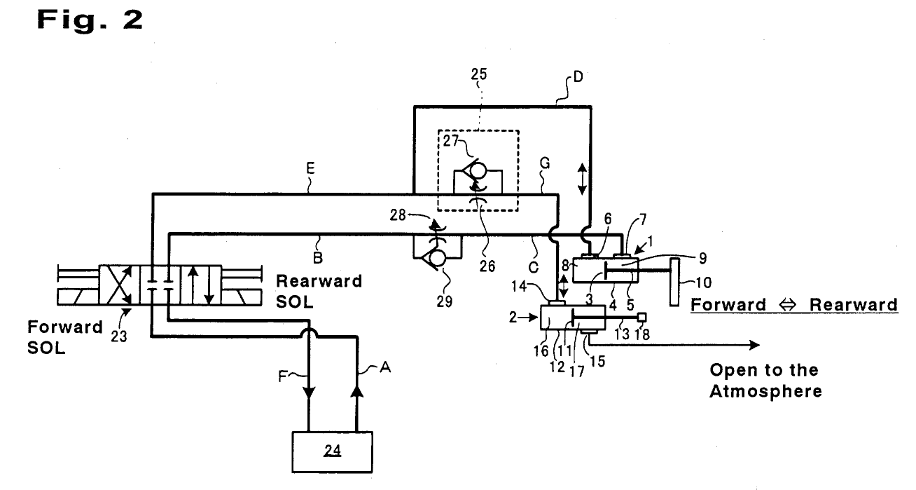

FIG. 1 is a longitudinal sectional view of the first embodiment of this invention, and FIG. 2 is a circuit diagram showing the operation fluid circuit of FIG. 1.

In FIG. 1, numeral 1 indicates a main cylinder of a cylinder device, that is, a driving cylinder for moving an object to be moved, and numeral 2 indicates a cushioning cylinder for causing the driving cylinder 1 to perform cushion operation.

As shown in FIG. 2, the driving cylinder 1 comprises a driving piston 3, a driving cylinder tube 4 slidably retaining the driving piston 3, a driving piston rod 5 for the driving piston 3, a forward side driving supply/discharge port 6, and a rearward side driving supply/discharge port 7; a forward side driving operation chamber 8 and a rearward side driving operation chamber 9 are respectively formed on the front and back sides of the driving piston 3 in the driving cylinder tube 4.

A first engagement member 10 is mounted to an end portion of the driving piston rod 5.

The cushioning cylinder 2 comprises a cushioning piston 11, a cushioning cylinder tube 12 slidably retaining the cushioning piston 11, a cushioning piston rod 13 of the cushioning piston 11, a forward side cushioning supply/discharge port 14, and a rearward side cushioning supply/discharge port 15; a forward side cushion operation chamber 16 and a rearward side cushion operation chamber 17 are respectively formed on the front and back sides of the cushioning piston 11 in the cushioning cylinder tube 12.

A second engagement member 18 is provided at an end portion of the cushioning piston rod 13.

The driving cylinder 1 and the cushioning cylinder 2 are fixed to a retaining frame 19 so as to be parallel to each other. Then, the end portions of the driving piston rod 5 and the cushioning piston rod 13 protrude rearwards from a retaining frame 19, and the first engagement member 10 and the second engagement member 18 are respectively mounted to the protruding end portions.

Further, threadedly engaged with the first engagement member 10 are a driving stroke adjusting screw 21 whose forward end can abut a stopper 20 fixed to the retaining frame 19 and a cushioning stroke adjusting screw 22 whose forward end can abut the second engagement member 18.

In FIG. 2, numeral 23 indicates a solenoid valve for switching between advance, retreat, and stop of the cylinder device. When causing the cylinder device to advance, the solenoid valve 23 effects line switching as follows: A-B-C and D-E-F so as to send operation fluid supplied from an operation fluid supply source 24 to the rearward side driving supply/discharge port 7 of the driving cylinder 1 and to return operation fluid discharged from the forward side driving supply/discharge port 6 to the operation fluid supply source 24; when causing the cylinder device to retreat, the solenoid valve switch effects line switching as follows: A-E-D, A-E-G, and C-B-F so as to send the operation fluid supplied from the operation fluid supply source 24 to the forward side driving supply/discharge port 6 of the driving cylinder 1 and the forward side cushioning supply/discharge port 14 of the cushioning cylinder 2 and to return the operation fluid discharged from the rearward side driving supply/discharge port 7 to the operation fluid supply source 24.

The rearward side cushioning supply/discharge port 15 of the cushioning cylinder 2 is not connected to the above line and is left open to the atmosphere, whereby the rearward side operation 17 communicates with the atmosphere.

Numeral 25 indicates an operation fluid throttling means provided between the lines E and G provided between the solenoid valve 23 and the forward side cushioning supply/discharge port 14 of the cushioning cylinder 2; the operation fluid throttling means 25 serves to throttle the flow of the operation fluid in the cushioning cylinder 2 when the cushioning piston 11 advances.

The operation fluid throttling means 25 is provided with a throttle valve 26 which allows adjustment of throttling amount and a check valve 27 connected in parallel to the throttle valve 26.

When the operation fluid flows from G to E through switching of the solenoid valve 23 to cause the cushioning cylinder 2 to advance, the check valve 27 is closed, and the operation fluid is throttled by the throttle valve 26, the flow velocity of the operation fluid in the line being reduced according to the throttling amount.

Numeral 28 indicates a throttle valve provided between lines B and C, and numeral 29 indicates a check valve connected in parallel to the throttle valve 28.

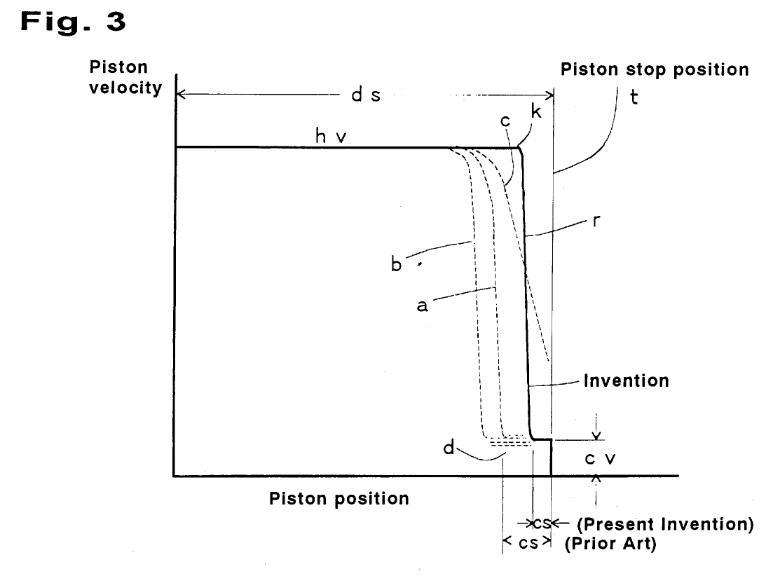

The cushion operation of the cylinder device of this embodiment will now be described with reference to FIGS. 2 and 3.

To cause the cylinder device to advance, the solenoid valve 23 is switched, and operation fluid is sent to the rearward side driving operation chamber 9 by way of lines A-B-C and the rearward side driving supply/discharge port 7. At this time, the check valve 29 is opened, so that the operation fluid in the lines is not throttled, and the driving piston 3 advances at a high velocity hv, the operation fluid in the forward side driving operation chamber 8 being returned to the operation fluid supply source 24 by way of the port 6 and the lines D-E-F.

Before the driving piston 3 reaches its stop position t, the forward end of the cushion stroke adjusting screw 22 of the first engagement member 10 moving integrally with the driving piston 3, abuts the second engagement member 18 on the cushioning cylinder 2 side (as indicated at k in FIG. 3); thereafter, the driving piston 3 advances integrally with the cushioning piston 11.

When the cushioning piston 11 starts to advance, the operation fluid in the forward side cushion operation chamber 16 is pushed out to the forward side cushioning supply/discharge port 14 side. The operation fluid pushed out closes the check valve 27 with its flow, is strongly throttled by the throttle valve 26, and flows through the lines G-E-F at low flow velocity, reducing the forward movement velocity of the cushioning piston 11 and the driving piston 3 to the cushion operation velocity cv and effecting transition to cushion operation of the cylinder device. During the cushion operation, the flow velocity of the operation fluid on the driving cylinder 1 side is naturally also reduced.

When the forward end of the driving stroke adjusting screw 21 of the first engagement member 10 abuts the stopper 20, and the driving piston 3 reaches the piston stop position t, the driving piston 3 stops, and the second engagement member 18 on the cushioning cylinder 2 side is not further pressurized, so that the cushioning piston 11 also stops.

In this way, until it engages with the cushioning piston 11 of the cushioning cylinder 2, the driving piston 3 for the driving cylinder 1 advances at a high velocity hv; when the first engagement member 10 of the driving cylinder 1 abuts the second engagement member 18 of the cushioning cylinder 2 to be engaged therewith, it is regulated by the cushion operation of the cushioning piston 11 and its velocity is reduced.

The cushion stroke cs can be varied by adjusting the cushion stroke adjusting screw 22 through getting in and out thereof. The driving stroke ds can be varied by adjusting the driving stroke adjusting screw 21 through getting in and out thereof.

The point k at which the first engagement member 10 abuts the second engagement member 18 does not fluctuate under the influence of a variation in the temperature of the operation fluid, wear of the parts, etc., and the point for switching to cushion operation is very stable. Further, unlike the conventional structure in which the deceleration starts after the cushion rod 506 has entered the cushion spigot portion 508 to some degree, the operation fluid throttling means 25 at the time of this switching can be previously set to an optimum throttling amount; the deceleration is started immediately after the operation fluid has flowed into the operation fluid throttling means 25; thus, its response is quick, and the requisite time for deceleration is greatly reduced (as indicated at r in FIG. 3).

Since the cushion operation switching point is stable, and the requisite time for deceleration is short, it is possible to set the cushion stroke cs to a requisite minimum level, and even if the cushion operation start position k is set quite near the stop position t, the cushioning effect at the time of stoppage can be obtained safely and reliably. Further, by the reduction amount of the cushion stroke cs, the high velocity (hv) movement time can be lengthened, thereby reducing the operation cycle time.

In the embodiment shown in FIG. 1, the second engagement member 18, for example, may serve as a cushion stroke adjusting screw, and the cushion stroke adjusting screw 22 may be formed as a stationary pin which does not allow adjustment. Further, it goes without saying that the cushion stroke adjusting means and the driving stroke adjusting means can be provided at positions separate from the first and second engagement members.

Second Embodiment

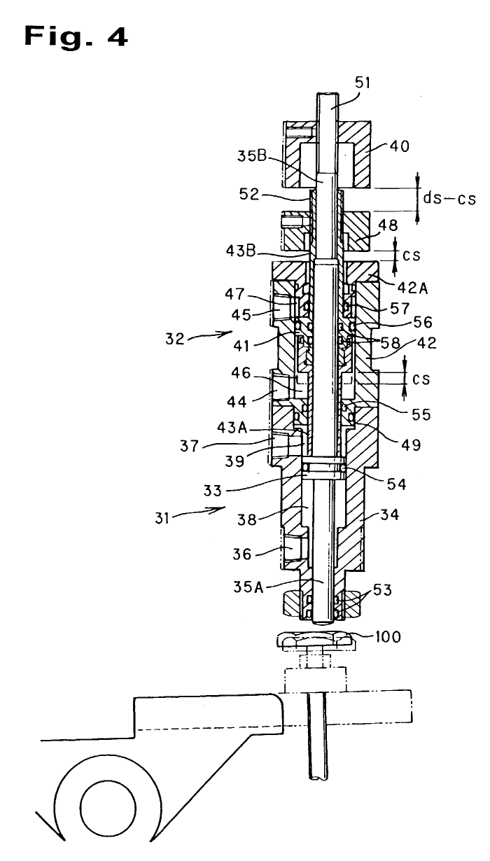

FIG. 4 is a longitudinal sectional view showing the second embodiment of this invention. In the second embodiment, the driving cylinder tube and the cushioning cylinder tube are formed concentrically, thereby forming a compact cushion cylinder device.

In FIG. 4, numeral 31 indicates a driving cylinder, and numeral 32 indicates a cushioning cylinder.

The driving cylinder 31 comprises a driving piston 33, a driving cylinder tube 34 slidably retaining the driving piston 33, a front driving piston rod 35A of the driving piston 33, a rear driving piston rod 35B of the same, a forward side driving supply/discharge port 36, and a rearward side driving supply/discharge port 37; the portion of the interior of the driving cylinder tube 34 on the front side of the driving piston 33 constitutes a forward side driving operation chamber 38, and the portion thereof on the rear side of the driving piston 33 constitutes a rearward side driving operation chamber 39.

The forward end portion of the front driving piston rod 35A protrudes forwards from the driving cylinder tube 34; when the piston 33 advances, It hits a driven member 100 to move the same. The forward end portion of the rear driving piston rod 35B is formed as a screw portion 51, which is threadedly engaged with a first engagement member 40 also serving as a driving stroke adjusting means.

The cushioning cylinder 32 comprises a cushioning piston 41, a cushioning cylinder tube 42 slidably retaining the cushioning piston 41, a front cushioning piston rod 43A and a rear cushioning piston rod 43B of the cushioning piston 41, a forward side cushioning supply/discharge port 44, and a rearward side cushioning supply/discharge port 45; a forward side cushion operation chamber 46 and a rearward side cushion operation chamber 47 are respectively formed on the front and back sides of the cushioning piston 41 in the cushioning cylinder tube 42.

In this invention, the cushioning piston 41, the front cushioning piston rod 43A, and the rear cushioning piston rod 43B are collectively referred to as the cushioning piston portion. This cushioning piston portion is formed as a hollow sleeve, into which the rear driving piston rod 35B is slidably inserted, which is further passed through the cushioning piston portion, and the first engagement portion 40 is mounted to the forward end thereof as stated above.

An end portion of the rear cushioning piston rod 43B is formed as a screw portion 52, which is threadedly engaged with a second engagement member 48 also serving as a cushion stroke adjusting means.

The driving cylinder tube 34 and the cushioning cylinder tube 42 are fitted together in spigot-like fashion (49), and secured in position by a screw to form a concentric structure.

For sealing between the operation chambers 38, 39, 46, and 47 of this duplex-structure cylinder, and for sealing between the operation chambers and the exterior, O-rings are fitted in the sliding portions.

That is, an O-ring 53 between the driving cylinder tube 34 and the front driving piston rod 35A seals the forward side driving operation chamber 38 from the exterior; an O-ring 54 between the driving cylinder tube 34 and the driving piston 33 seals the forward side driving operation chamber 38 from the rearward side driving operation chamber 39; and an O-ring 55 between the cushioning cylinder tube 42 and the front cushioning piston rod 43A seals the rearward driving operation chamber 39 from the forward side cushion operation chamber 46.

Further, an O-ring 56 between the cushioning cylinder tube 42 and the cushioning piston 41 seals the forward side cushion operation chamber 46 from the rearward side cushion operation chamber 47; an O-ring 57 between the cushioning cylinder tube end portion 42A and the rear cushioning piston rod 43B seals the rearward cushion operation chamber 47 from the exterior; and an O-ring 58 between the cushioning piston 41 and the rear driving piston rod 35B seals the rearward driving operation chamber 39 from the exterior.

Next, the operation fluid circuit will be described with reference to FIG. 2. In the second embodiment, the driving cylinder 31 of FIG. 4 is connected instead of the driving cylinder 1 of FIG. 2, and the cushioning cylinder 32 of FIG. 4 is connected instead of the cushioning cylinder 2 of FIG. 2.

That is, the forward side driving supply/discharge port 36 of the driving cylinder 31 is connected to the line D of FIG. 2, and the rearward side driving supply/discharge port 37 is connected to the line C of Fig.2. The forward side cushioning supply/discharge port 44 of the cushioning cylinder 32 is connected to the line G of FIG. 2, and the rearward side cushioning supply/discharge port 45 is open to the atmosphere.

The cushion operation of the cylinder device of this embodiment will be described with reference to FIG. 3.

As in the first embodiment, to cause the cylinder device to advance, the solenoid valve 23 is switched to send operation fluid to the rearward side driving operation chamber 39. The driving piston 33 advances at a high velocity hv, and the operation fluid in the forward side driving operation chamber 38 is discharged to the operation fluid supply source 24.

Before the driving piston 33 reaches its stop position t, the front end surface of the first engagement member 40 moving integrally with the driving piston 33 abuts the rear end surface of the second engagement member 48 on the cushioning cylinder 32 side (as indicated at k in FIG. 3). Thereafter, the driving piston 33 advances integrally with the cushioning piston 41.

As in the first embodiment, the advancing velocity of the cushioning piston 41 is a cushion operation velocity cv, which is a low velocity, and the cylinder device is rapidly decelerated from the high advancing velocity hv to the cushion operation velocity cv.

When the front end surface of the second engagement member 48 abuts the end surface of the cushioning cylinder tube end portion 42A, and the driving piston 33 reaches the piston stop position t, the driving piston 33 and the cushioning piston 11 are stopped.

In the second embodiment, it is possible to adjust the cushion stroke cs by adjusting the screw of the second engagement member 48. Further, it is possible to adjust the driving stroke ds by adjusting the screw of the first engagement member 40. That is, as shown in FIG. 4, at the retreat position of the cushioning cylinder, the gap between the front end surface of the second engagement member 48 and the end surface of the cushioning cylinder tube end portion 42A is set to cs, and the gap between the front end surface of the first engagement member 40 and the rear end surface of the second engagement member 48 is set to “ds-cs”.

In this embodiment also, the point k where the first engagement member 40 abuts the second engagement member 48 does not fluctuate under the influence of a variation in the temperature of the operation fluid, wear of the parts, etc., and the point where switching to cushion operation is effected is very stable. Further,the response of the operation fluid throttling means 25 at the time of this switching is quick, and the requisite time for deceleration is very short (as indicated at r in FIG. 3).

Since the cushion operation switching point is stable, and the requisite time for deceleration is short, it is possible to set the cushion stroke cs to the requisite minimum level, and even if the cushion operation start position k is set quite near the stop position t, the cushioning effect at the time of stopping can be obtained safely and reliably. Further, the high velocity (hv) movement time can be lengthened by the reduction amount of the cushion stroke cs, thereby shortening the operation cycle time.

While in the second embodiment the cushioning piston portion is formed as a sleeve-like cushioning piston portion, into which the piston rod of the driving piston portion is slidably inserted, it is also possible in this invention to form the driving piston portion as a sleeve-like driving piston portion, into which the piston rod of the cushioning piston portion is slidably inserted.

As described above in detail, in this invention, there are provided a driving cylinder, a cushioning cylinder, and an operation fluid throttling means which when the cushioning piston of the cushioning cylinder advances, throttles the flow of the operation fluid in the cushioning cylinder to reduce the moving velocity or the cushioning piston to thereby effect cushion operation, in which when the driving piston of the driving cylinder advances to cause a first engagement member of the driving piston rod to abut a second engagement member of the cushioning piston rod, the velocity of the driving piston is reduced through regulation by the cushion operation of the cushioning cylinder, whereby there is no variation in the cushion operation due to dimensional errors in the cylinder parts, and the variation is mitigated in the cushion operation with passage of time and due to variation in the temperature of the operation fluid, making it possible to set the cushion operation start position of the driving cylinder with high accuracy.

Then, since the braking effect of the cushioning cylinder is immediately exerted in a stable manner, deceleration is quickly effected at the cushion operation start position, and the requisite time for the deceleration is short. Since the cushion operation start position does not fluctuate, it is possible to set the cushion stroke to the requisite minimum level, and it is possible to set the cushion operation start position quite near the stop position; since the low velocity cushion stroke can be reduced, the high velocity stroke can be so much the longer, making it possible to reduce the operation cycle time.

Further, by forming the driving cylinder and the cushioning cylinder into a concentric structure, it is possible to obtain a cushioning cylinder which is compact and superior in space efficiency.

When the first and second engagement members for engaging the driving piston with the cushioning piston also serve as cushion stroke adjusting means and driving stroke adjusting means, it is possible to achieve a reduction in the number of parts and cost.

By adopting a structure in which the operation fluid in the cushioning cylinder is solely in the forward side operation chamber of the cushioning piston and in which the rearward side operation chamber communicates with the atmosphere, it is possible to attain savings in the fluid pressure circuit and a reduction in cost.

What is claimed is:

1. A cushion cylinder device comprising:
a driving cylinder tube slidably retaining a driving piston;
a cushioning cylinder tube slidably retaining a cushioning piston;
a first engagement member provided on a driving piston rod of the driving piston;
a second engagement member provided on a cushioning piston rod of the cushioning piston; and
an operation fluid throttling means which when the cushioning piston advances, throttles the flow of operation fluid in the cushioning cylinder to reduce the moving velocity of the cushioning piston to thereby effect cushion operation,
wherein when the driving piston advances to cause the first engagement member to abut the second engagement member, the velocity of the driving piston is reduced through regulation by cushion operation of the cushioning piston.

2. A cushion cylinder device according to claim 1, wherein one of a cushioning piston portion and a driving piston portion is formed as a sleeve-like piston portion, into which the piston rod of the other piston portion is slidably inserted to form the driving cylinder tube and cushioning cylinder tube into a concentric structure.

3. A cushion cylinder device according to claim 1, wherein the throttling amount of the operation fluid throttling means is adjustable.

4. A cushion cylinder device according to claim 1, further comprising a cushion stroke adjusting means for adjusting the stroke of the cushioning piston.

5. A cushion cylinder device according to claim 4, wherein the first or second engagement member also serves as the cushion stroke adjusting means.

6. A cushion cylinder device according to claim 1, further comprising a driving stroke adjusting means for adjusting the stroke of the driving piston.

7. A cushion cylinder device according to claim 6, wherein the first engagement member also serves as the driving stroke adjusting means.

8. A cushion cylinder device according to claim 1, wherein the operation fluid in the cushioning cylinder is solely in an operation chamber on the forward side of the cushioning piston, and wherein an operation chamber on the rearward side thereof communicates with the atmosphere.
